(19) United States
(12) Patent Application Publication
(10) Pub. No.: US 2008/0046362 A1
(43) Pub. Date: Feb. 21, 2008

(54) Method of making secure on-line financial transactions

(76) Inventor: Frank Easterly, Midlothian, VA (US)

Correspondence Address: MICHAEL C. CESARANO, FELDMAN GALE, P.A., 201 S. BISCAYNE BOULEVARD SUITE 1920, MIAMI, FL, 33131, US

(21) Appl. No.: 11/464,694

(22) Filed: Aug. 15, 2006

(51) Int. Cl. G06Q 40/00

(52) U.S. Cl. 705/40

(57) ABSTRACT

A method of providing secure financial transactions using the internet creates virtual currency that is used to settle monetary obligations amongst authorized purchasers, merchants, and other financial operators. The network operator maintains available funds in pooled fund accounts at various financial institutions, and uses those funds to purchase and sell virtual currency that may then be used on-line. Actual monetary transfers take place between pooled accounts using traditional automated clearing house (ACH) networks, pursuant to instructions provided to financial institutions by the network operator. User authentication and authorization are provided through a dual registration process, and a user's identity may be authenticated using a physical medium or a PIN. Instructions may be given remotely to the network operator through cellular telephones and PDAs.

### FIELD OF THE INVENTION

The present invention relates to the authorization, authentication, and settlement of commercial remittance transactions performed over the internet and over telephone wired and wireless networks.

### BACKGROUND OF THE INVENTION

Transaction authorization, authentication and settlement over the internet and telephone networks are subject to breaches in user privacy and security that create an insecure environment that promotes fraud. The cost of unabated fraud is ultimately borne by the user. Most current internet-dependent remittance transaction technologies contemplate the use of a physical or virtual credit card or debit card for settlement, or reside on an operating referral platform of credit cards or debit cards in the execution of commercial remittance transactions. However, in no case is the physical card present at the point of the transaction over the internet or phone network and hence a condition in the on-line remittance industry known as “card not present” exists.

For debit transactions, a “card not present” condition results in an “offline debit” transaction. Offline debit transactions differ from “online debit” transactions in that online debit transactions are authorized and authenticated through the use of a Personal Identification Number, or PIN, known only to the user of the card; and deductions from a purchaser's account occur immediately. Offline debit transactions, in contrast, have two distinguishing characteristics: First, transactions are signature-based, rather than PIN based; and second, consumer accounts are debited one or two days after the transaction rather than immediately. As a result of these differences in debit transactions, the risk of fraud or of a purchaser's inability to finally settle a transaction is substantially greater in offline debit transactions.

Similar considerations apply to credit card transactions which, as with offline debit transactions, are signature based, and for which final settlement may be delayed a number of days or weeks following the transaction.

A number of technologies have been introduced to mitigate the risk of fraud and to eliminate potential breaches in user privacy and security. However, fraud continues to track the growth of internet and telephone network remittance transactions. The fundamental problem remains that the seller cannot physically verify the buyer, the items purchased, or the way to convey the goods and services in time and space at the virtual point of the transaction to authorize, authenticate and settle a “card not present” transaction in real time.

The present invention is an improvement on credit card methods and systems and signature debit methods and systems as devices for supporting internet and telephone network authorization, authentication and settlement of commercial remittance transactions. This invention provides methods and systems to settle internet or phone network commercial remittance transactions with the characteristics of immediacy, security and finality enjoyed in the physical world of debit transactions. This invention goes beyond the method and systems of the physical world of signature debit, as it can transform a settlement transaction from a debit transaction that is “pulled” into a network for settlement by the merchant into a credit transaction that is “pushed” by the purchaser through the purchaser's bank or any “originating draft financial institution” (ODFI). Settlement occurs through an internal clearing mechanism which the ODFI may control or that it out sources to a third party processor, or through an automated clearing house (ACH), thereby reducing the risk and the expense of the transaction settlement.

Current internet credit card transactions in a “card not present” condition separate authorization, authentication and settlement functions through a complex interoperable network that includes intermediaries to absorb the risk and expense of authorization, authentication and settlement. The transactions “float” through one or more networks that are traditionally governed by the rules and policies of the credit card associations (comprised of the member banks) and that typically take days to settle with grace periods of weeks built into the protocol to allow the resolution of disputed transactions. These traditional internet commercial remittance transactions are subject to problems of security and privacy and they are not immediate, secure or final at settlement.

Internet debit card transactions in the “card not present” condition link authorization and settlement functions in real time through a complex of physical networks that can operate in real time or that can “float” through the use of intermediaries and transaction limits to mitigate the risk of fraud at settlement. These transactions move through regional debit networks that are maintained by national and international debit associations that govern the rules and policies of the debit transactions. Debit transactions tend to be transparent to the card holder's bank and his demand deposit account. While debit transactions over the internet are immediate and secure they are not final since the authentication function can only be characterized as a pre-payment with a promise to fulfill at a later time.

### SUMMARY OF THE INVENTION

This invention improves upon the prior art by supplementing it with an additional proprietary network (a virtual private network, or VPN), referred to herein as “the Extranet,” that interfaces with member banks, and with registered merchants and other users to facilitate electronic transactions that are at once more secure and that reduce the time for settlement and clearance of these transactions.

This invention provides communications links between one or more Extranet Servers and financial institutions, merchants, parcel shippers and freight handlers, and customers or other users of the system, whereby transactions can be initiated, authenticated, and finalized through channels outside existing credit and debit networks. Entities using the communications links of this invention do not communicate directly with each other, but communicate only with a proprietary server (the Extranet Server, or “EXN Server”). The EXN Server, in turn, has operating agreements with member financial institutions, and can direct them to act to carry out the instructions of authorized users. In this description, the term “Extranet Server” or “EXN Server” is not limited to a single server machine, but may be comprised of a number of interconnected servers operating together to perform the described server functions. The term “banks” is used generically to refer, not only to banking corporations, but to encompass other consumer financial institutions such as credit unions and the like. The EXN Server is operated by an EXN Operator that carries out administrative functions required by the system, such as registering users, corporate entities and banks to use the system, entering into operating agreements with banks, and opening and maintaining escrow accounts (referred to as “pooled accounts”) at selected banks.

The EXN Server recognizes each authorized user through a unique personal alphanumeric code (“PAC”) that authenticates the user to the Server and permits secure authorization for transactions to be made and referenced through the PAC. Authorization codes, which may be encrypted, may be included on a physical medium (such as a CD or magnetic strip plastic card), and authentication may also be further supplemented by requests for personal information through a challenge and response dialogue, which authenticates the user to the EXN Server and permits transactions to be made in the user's name. Alternatively, authorization may be had through the user's providing information through a downloadable application.

Users are cross-referenced to bank accounts (direct deposit accounts, or “DDAs”) they control, and through which the user can make withdrawals, convert available funds into virtual funds (“e-cache”) that may be used to make purchases, to settle accounts on the internet, or that may be reconverted from e-cache into available funds in a DDA. Banks are identified using a bank identification number.

In its simplest form, this invention permits a user to instruct the EXN Server to initiate a financial transaction. Transactions are carried out in cyberspace using movable icons representing e-cache that the user can manipulate using a computer mouse. The user is presented with a variety of tools to carry out the transaction, such as a virtual Automated Teller Machine (vATM) that can be used to obtain or redeem e-cache, an e-Wallet, which represents a repository to hold e-cache, and a merchant's e-register, which will accept e-cache in payment for internet or in-person transactions.

Concurrently, the EXN Server issues instructions to member banks that will be carried out on existing financial networks. In so doing, the EXN Server can make predetermined choices for structuring the transaction, taking into consideration such factors as transactional costs charged by other financial networks for various types of transactions, the time for settlement of the transaction, and the finality and immediacy to be accorded the transaction in real time.

In practice, the EXN Server maintains virtual accounts on-line, permitting users to convert available funds from the user's DDA into e-cache using a virtual ATM, and to use e-cache for purchases, bill paying, or any other electronic transfer or payment that is recognized by the system. Virtual transfers are recorded by the EXN Server until a user reconverts e-cache back into available funds, at which time actual monetary transfers may be initiated by the EXN Server to balance users' accounts. The process is akin to the EXN Operator's “selling” e-cache and withdrawing available funds from a user's DDA, or “buying” e-cache and depositing available funds into a user's DDA. E-cache may be held in a user's e-wallet until used, and while being so held is not available for withdrawal through conventional means. Such virtual funds may be used on-line for purchases, remittances, or transfer; or, if desired, may be redeposited into the user's bank account where they will become available for conventional withdrawals. Virtual funds may also be maintained as e-cache by their recipients and re-used in other on-line transactions prior to being converted back to actual funds. Through this process, the costs of real monetary transactions may be diminished or eliminated.

The EXN Server provides tools and facilities to perform, or to enable a user to perform, the functions of funding a transaction, authenticating a user, authorizing a transaction, and settling a transaction. Funding is the process of providing e-cache to a user, for example, through a virtual ATM, as is described below. Authentication is the process of authenticating a registered user to conduct approved transactions through the EXN Server. Authentication involves the use of a PAC that is recognized by the EXN Server, and may be embedded on a physical medium (compact disc or credit card) bearing encoded information, or a challenge and response procedure. Authorization is the user's act of physically moving a computer mouse or keyboard to cause a transfer of e-cache to take place—a transaction that will be reconciled by an actual transfer of available funds either simultaneously or at some point in the indefinite future. Settlement of an EXN Server transaction occurs when available funds or their virtual equivalent, e-cache, are transferred in consideration of an obligation and the transfer has been recorded in each party's account, which may be a bank account (DDA) or an e-register. Settlement in real funds occurs when e-cache is converted into available funds in a pooled account controlled by the EXN Operator which are then transferred into a user's account using an automated clearing house commercial credit draft (ACH CCD).

All of these facilities and functions can take place either as intra-bank transactions, in which transfers and accounting take place within a single bank; or as inter-bank transactions, in which transfers take place between banks and institutions, with or without the assistance or intervention of intermediaries. The most significant distinction between intra-bank and inter-bank transactions is that external processing costs associated with inter-bank transfers of available funds using prior art systems will generally be somewhat greater than for intra-bank transfers.

E-cache is created or destroyed by the EXN Operator as users and merchants convert available funds in their bank accounts to e-cache, or redeem e-cache to obtain available funds. The EXN Operator maintains a number of pooled funds accounts in selected banks. The conversion of available funds into e-cache normally takes the form of a user's withdrawing e-cache from a vATM being operated by the EXN Server. As the EXN Server provides e-cache to the user, it simultaneously directs the user's bank to remove available funds from the user's DDA and place them into a pooled funds account owned by the EXN Operator.

The EXN Operator maintains pooled funds accounts at numerous banks throughout the world, and the user's available funds can be transferred from the user's DDA into a pooled funds account at the user's bank without incurring transaction costs. If the EXN Operator does not maintain a pooled funds account at the user's bank, the user's funds can be transferred to any other bank in which the EXN Operator maintains a pooled funds account.

When a user desires to reconvert e-cache into available funds, the EXN Server will initiate a transfer of actual funds from one of the EXN Server's pooled funds account into the user's DDA, and will simultaneously destroy the e-cache tendered by the user. One advantage of maintaining a number of pooled funds accounts at different banks is that the EXN Operator then has a choice of accounts from which to transfer available funds when a user, who may be an individual, a merchant, or some other entity, reconverts e-cache into available funds, and can thereby minimize or avoid transaction costs charged by other financial networks.

Because transactions may be completed using e-cache, a user who is a purchaser can actually control the terms for settling a transaction. That is, a “self-directed” settlement will occur whenever the purchaser directs the terms of the transaction and settlement of the virtual funds. This will be manifested as a double authentication for an on-line purchase transaction where the purchaser and the merchant are both authorized users of the system of this invention. For example, a merchant who is registered to use this system will include a button-icon on its web site to indicate that it can conduct transactions using the Extranet of this system. A purchaser who is registered with the EXN Operator, may visit the merchant's site to purchase items. After selecting items that are placed within a virtual “shopping cart,” the purchaser will click on the Extranet button to initiate the purchase. When the button is clicked, the EXN Server will be notified that a transaction is taking place. The EXN Server then conducts separate internet sessions with the purchaser and the merchant. The clicking of the Extranet icon constitutes the purchaser's first authentication of the items to be purchased, which are then in the purchaser's shopping cart on the merchant's site. The EXN Server downloads information regarding this purchase from the merchant's site, and presents that information to the purchaser. The EXN Server will then wait for the purchaser to confirm the purchase of those items (the second authentication), which is signified by the purchaser's moving animated icons on the computer screen. The purchaser confirms the purchase by dragging and dropping tokens representing e-cache from an icon representing the purchaser's wallet (“e-Wallet”) to an icon representing the merchant's account (“e-Register”). At that point, the merchant will have received e-cache into its e-register, and can use it to settle other transactions over the internet, or can convert it into available funds that may thereafter be withdrawn from the merchant's bank account.

Prior to making a purchase, the purchaser must have obtained e-cache to fund the transfer. This is done through a vATM in which the purchaser has caused the EXN Server to transfer funds from the purchaser's DDA into one of the pooled funds accounts maintained by the EXN Operator. Concurrently, an equivalent amount of e-cache is placed in the purchaser's e-Wallet. Following an on-line transaction, if the merchant should wish to convert its e-cache into available funds, it can do so by depositing e-cache into its account using a vATM, or by using some other available tool. To accomplish this, the EXN Server will instruct a bank maintaining the EXN Operator's pooled account to “push” funds from the pooled funds account into the merchant's bank account in a credit transaction. The merchant may then withdraw available funds from its account.

In this transaction, the purchaser has set up a credit, rather than a debit transaction, and has controlled the terms of the transaction and settlement. In this self-directed settlement, the separate steps of authorization and authentication have been bypassed, and the transfer of funds has appeared seamless to the purchaser. Because the system empowers the purchaser to self-settle and self-fund, the transparency of the transaction has been increased, and the merchant simply accepts e-cache into its account where it may later be converted into available funds.

In a further embodiment of the invention, an authorized user can send funds electronically via a wire transfer from the user's DDA to third parties. This functionality may be implemented through the use of an electronic demand deposit account (“eDDA”) which would operate similarly to an e-wallet to receive and transfer e-cache as directed by the user. This function may be used where the funds recipient is not an authorized user of the system and has no means for receiving e-cache or converting e-cache to available funds. In this case, the conversion of e-cache into available funds would take place in a transaction between the recipient bank and the EXN Operator. Following the conversion, the available funds will be posted to the intended recipient's account at that bank.

The system of this invention is immune to hackers who are unable to obtain personal information such as a user's name or social security number, or to match a user to a bank or bank account number, or bank account balances. In one embodiment, the system permits a user to access the server from a computer only following authentication provided by a physical medium which can be read by the computer (CD reader, or magnetic card swipe) and forwarded to the server. In this case, the physical medium may also be protected from unauthorized use by requiring the user to enter a PIN, or to provide personal predetermined information known only to the user.

In a further embodiment, a dual-use physical medium may be provided for a user's convenience. In this embodiment, the physical medium will have digital information storage characteristics of a compact disc and will also be shaped like a conventional rectangular plastic card with a magnetic strip. This physical medium would be usable in a card insertion or card-swiping form of card reader, or could be read from a conventional compact disc drive integral to a computer. In another embodiment, the physical medium could have one rectangular or straight end having the thickness of a credit card and further have a magnetic strip along the straight edge. The remainder of the medium would be in a compact disc format and could be read by a conventional CD drive. A dual-use physical medium provides convenience to the user who must be able to use the medium with different card-reading devices, while ensuring extraordinary security through the encryption of information on the medium to which access is provided only through the use of a PIN.

In a further embodiment, and in specific situations in which user preference dictates, transposition of the bank identification number (BIN) and the user's personal account number may be taken directly from a check for a user's DDA may be used to obtain e-cache through the system vATM.

This invention permits the on-line payment authorization and settlement of transactions with security and finality, and provides tools for the settlement of commercial remittance transactions. The Extranet of this invention is used to authorize, authenticate, and settle with finality certain financial transactions that heretofore have not been settled and finalized on-line using traditional electronic funds transfer (“EFT”) networks. The proprietary network of this invention and the EXN Server operate securely to determine virtual funds availability by user account, authentication of transactions made by users, and to initiate credit funds transfers over EFT networks that have the characteristics of “debit-online” transactions that may be settled with finality in real time.

The invention ensures security and fraud reduction by requiring all communications to originate or terminate at the EXN Server, and by limiting user information being communicated over the network to arbitrary codes that are generated when an account is established, and that are known only to the EXN Server. Other than billing and account-identification information that may be stored at a remote location, the EXN Server does not maintain or transmit information sufficient to permit hackers or unauthorized eavesdroppers to identify a user of the system or an owner of an account at a member bank.

This method effectively transforms a prior art automated clearing house (ACH) debit transaction into an ACH credit transaction, and reduces the risk of settlement and the time required for settlement to the member bank. This method also improves upon debit-like transactions since the merchant is not required to state a “not later than” fulfillment date, or to provide confirmation and acceptance of this date to the user.

The invention includes a method of establishing an account to use the proprietary network through a dual level, two-party (account holder and account holder's bank) registration process that utilizes an encrypted physical medium, such as a credit card or compact disc provided by the account holder's bank or credit union. The dual level registration process incorporates a confidential registration with the bank where the user's demand deposit account resides, and a subsequent registration with the Extranet Operator. In the normal registration process, the user first registers with the bank and receives a pre-registration identification number. The user then registers with the Extranet, providing the pre-registration identification number assigned by the bank. The Extranet and the bank then engage in a registration dialog culminating in the user's being assigned a unique personal alphanumeric code (PAC) that thereafter identifies the user to the Extranet.

Transactions using this invention are carried out through the use of virtual tender (e-cache), which represents money, and is depicted as paper money or coin icons on a computer screen. The icons can represent different denominations of international currencies, depending upon predetermined factors such as users' choices or the situs of a transaction, and can be manipulated on screen through a user's physical movement of a mouse (or other computer pointing device) to cause the tender to be “withdrawn” from a virtual ATM or electronic wallet, and “paid” to a merchant for products or services, or “deposited” into a v-ATM account or e-Wallet.

The invention can also be utilized using a mobile device, such as a cellular telephone or a PDA (for example, a Blackberry®) and in one embodiment permits a user to authorize or execute a previously arranged transaction by sending a signal or code from a mobile device to the EXN Server. Physical authentication of a transaction may be provided by keying in a code or PIN to a mobile device. When supported by an appropriate contractual agreement, physical acts such as entering a PIN or manipulating a computer mouse to drag and drop animated tender on a computer screen, may be given the same or similar legal finality as is accorded to a signature on a draft or note.

In one embodiment of the system of this invention, users can select and pay for delivery methods for purchased items, and can thereafter track delivery status. Through agreements with delivery companies, the EXN Operator can present a purchaser with delivery options for purchased items that include direct payment from the purchaser's bank account to the shipping company. This is in contrast to current shipping procedures in which the merchant arranges and collects for—and frequently includes a surcharge for—shipping its products to purchasers. As a further enhancement, the EXN Operator can also provide tracking information for purchases made using the system of this invention. In this case, the EXN Server maintains a table cross-referencing a user's purchases made on-line with tracking and status information available from shippers, making it unnecessary for users to record or remember tracking numbers provided by a given shipper, and permitting users to view tracking and status information for all pending deliveries from one integrated display, rather than to track each shipped item individually.

It is an object of this invention to utilize existing host networks already in place in the form of the internet, wired and wireless phone networks, and cable systems, to supplement a proprietary Extranet in performing the functions of transaction authorization, authentication, and settlement with immediacy and finality within a secure environment.

It is another object of this invention to eliminate breaches in user privacy in transactions conducted over the internet which may lead to identity theft or that expose the user's personal financial information, including the user's credit card data, debit card data or personal check data.

It is a further object of this invention to adapt the characteristics of a physical world ATM through a proprietary Extranet having a virtual device for transposing a user's available funds into animated virtual tender that resides inside the Extranet to settle commercial remittance transactions on-line.

It is another object of this invention to store the virtual funds in the user's virtual account for as long as the user desires, for convenience of access and for settlement of future transactions.

It is an object of this invention to adapt the characteristics of a physical world ATM through a proprietary Extranet having a virtual device to decompose a user's virtual funds into available funds.

It is yet a further object of this invention to use a proprietary network to transfer a user's virtual funds to a virtual merchant register where the virtual funds can be converted into available funds by the merchant, or can be further used on-line by the merchant in future transactions.

It is another object of this invention to adapt a physical world ATM through the Extranet as a virtual device to transpose available funds into a virtual demand deposit account from which virtual funds can be decomposed into electronic transfers to another Extranet user's virtual demand deposit account.

It is a further object of this invention to decompose virtual funds on the Extranet into available funds.

It is an object of this invention to provide the user with means to settle transactions over the internet using animated virtual funds that the user moves from one virtual account to another with a computer mouse or a phone “scroll” without exposing the transaction to outside financial institutions.

Still a further object of this invention is to create proprietary networks between member banks, merchants, parcel fulfillers, phone network operators, electronic billers and Extranet users to eliminate processing fees and to increase the use and acceptance of the networks for commercial remittance transactions.

It is yet another object of this invention to integrate the authentication, processing and deployment functions of a debit-like device using the internet with a virtual private network to provide the user with the immediacy, security and finality similar to a physical world debit transaction.

Still another object of this invention is to create a dual level one time registration function between the user, the user's bank and a proprietary Extranet in which the registration functions are separated, the registration function being housed on a card or other physical device.

It is yet another object of this invention to absorb the risk of the merchant acquiring function without a direct charge to the merchant.

It is an additional object of this invention to utilize a physical card, DVD, CD-ROM or other intermediary device placed in a user's computer or phone to create a “card presence” during commercial remittance transactions conducted over the internet or in the physical world of merchants' point of sale (POS) transactions.

Still another object of this invention is to combine the physical security of the card device in the user's computer with a unique personal identification number (PIN) known to the user and associated with that card, and to require the user to successfully answer a series of challenge and response questions before giving the user access the Extranet methods and systems.

It is the object of this invention to add an additional layer of security to give the user the option to authorize each commercial remittance transaction with a cell phone through short message service (SMS) text messaging to validate a commercial remittance transaction before it is processed through the Extranet.

Yet a further object of this invention is to reduce the risk and expense of debit like transactions over the internet by avoiding the need for merchants to initiate debit-like transactions over the internet to provide the user with a “not later than” shipping date and to obtain user confirmation of that “not later than” date.

### BRIEF DESCRIPTION OF THE DRAWINGS

FIG. 1 diagrammatically shows typical connections of the Extranet of this invention to the EXN Server and to users and banks.

FIG. 2a depicts a computer display for the conversion of available funds into e-cache using a vATM.

FIG. 2b shows the logical flow of the actions depicted in FIG. 2a.

FIG. 3a shows a computer display for the reconversion of e-cache into available funds using a vATM.

FIG. 3b depicts the logical flow of the actions shown in FIG. 3a.

FIG. 4 shows how EXN pooled accounts use ACH credit transactions to provide available funds for interbank transactions.

FIG. 5 depicts an ACH credit transaction in which the RDFI does not maintain an EXN pooled account.

FIG. 6a provides an overview of the Extranet, including user tools available through the EXN Server.

FIG. 6b shows details for typical services available through the EXN Server.

FIG. 7 depicts a wireless embodiment of the invention.

FIG. 8 is a view of a physical medium that provides security to the invention.

FIG. 9 shows the preliminary steps for Extranet registration when a user opens a DDA with a bank.

FIG. 10 graphically depicts the steps showing a user's registration to use the Extranet.

FIG. 11 demonstrates a typical consumer on-line transaction using the invention.

### DETAILED DESCRIPTION OF THE PREFERRED EMBODIMENTS

This invention provides methods for ensuring secure electronic fund transfers using computer networks and networking devices. The invention operates as an overlay to traditional prior art networks that support ACH transactions.

### DETAILED DESCRIPTION OF THE PREFERRED EMBODIMENTS

The Extranet of this invention is hosted indirectly through member banks who are also directly connected to one of the ACH networks that provide banks with means to transfer funds between banks on behalf of their customers. The EXN Server is a proprietary server and network that is operated by an EXN Operator. The EXN Operator is authorized by member banks or other financial or non-financial institutions (collectively referred to herein as “banks”) to originate ACH transactions with member banks on behalf of the banks' account holders through operating agreements with each member bank. When an operating agreement is executed with a bank, the EXN Server establishes a discrete, secure network connection to that bank, and creates potential indirect access for all that bank's demand deposit account (DDA) customers to the EXN Server.

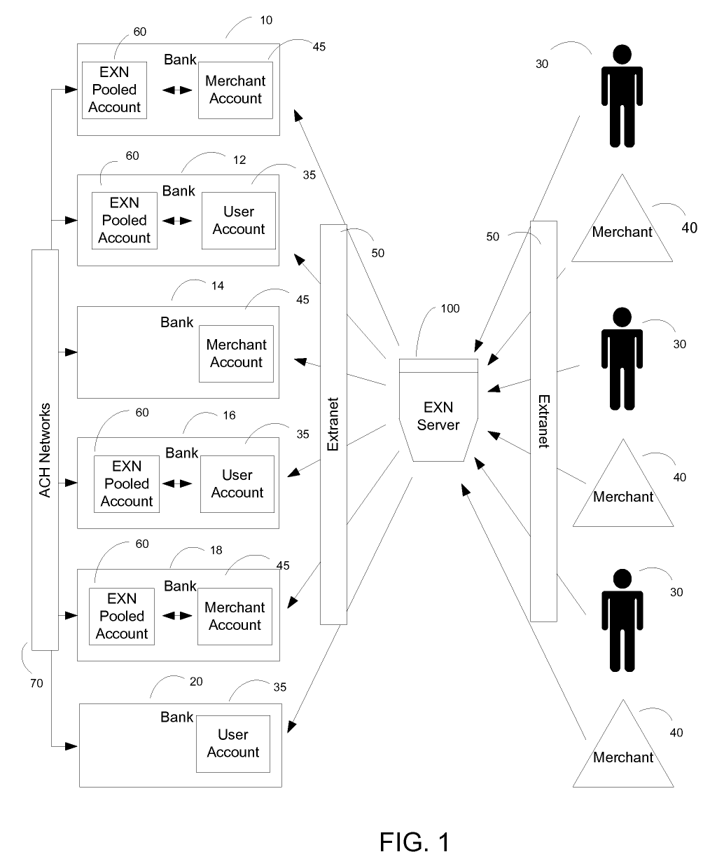

FIG. 1 depicts the EXN network of this invention having a proprietary EXN Server 100, a number of member banks 10-20, a plurality of Purchasers 30, and a plurality of Merchants 40. Each member bank maintains accounts for its patrons. In FIG. 1, merchants' accounts 45 and purchasers' accounts 35 are shown. The invention, however, is not limited to any particular type of account holder, and the accounts shown in FIG. 1 are representative of all entities who use the system. Selected member banks 10, 12, 16, 18 also maintain a pooled accounts 60 in the name of the EXN Operator.

Banks 10-20 are also each connected to traditional ACH networks 70 which may be any of the existing networks that provide automated clearing house services. In accordance with the invention, the EXN Server 100 has a connection to each bank, and to each user, through the Extranet 50. As shown in FIG. 1, the primary communications between users 30, 40 and the EXN Server 100 take the form of instructions from a user 30, 40 to the server directing that some action be taken. In responding to those communications, the EXN Server 100 will instruct member banks to initiate monetary transfers. Such transfers may involve only internal bank transfers, such as an instruction to move available funds from a user's account into an EXN pooled account maintained at the bank; or, such instructions may involve initiating an ACH transfer of funds between banks. As a general rule, regardless whether the transfer will be an intrabank transfer or will transfer money from one bank to another, the transaction will be initiated as a preformatted ACH CCD, that is, a request to initiate an ACH transaction. When the transaction is carried out, however, it may be discovered that the transferring and receiving accounts are within the same bank. Whenever that occurs, an “on us” transaction will be made in which the ACH is bypassed and ACH transaction costs are eliminated. This will be the case whenever a single bank maintains both an EXN pooled account and a user account.

Although the system supports and facilitates a variety of two-or-more party electronic transactions, each such transaction will have at least two components. In a typical on-line transaction using e-cache, the first component will involve a user's converting of available funds in a bank account into e-cache. The second component will involve the reconversion of a user's e-cache into available funds. On-line transactions that occur using only e-cache will be handled internally by the EXN Operator, and will appear to be transparent to the ACH financial networks and the member banks.

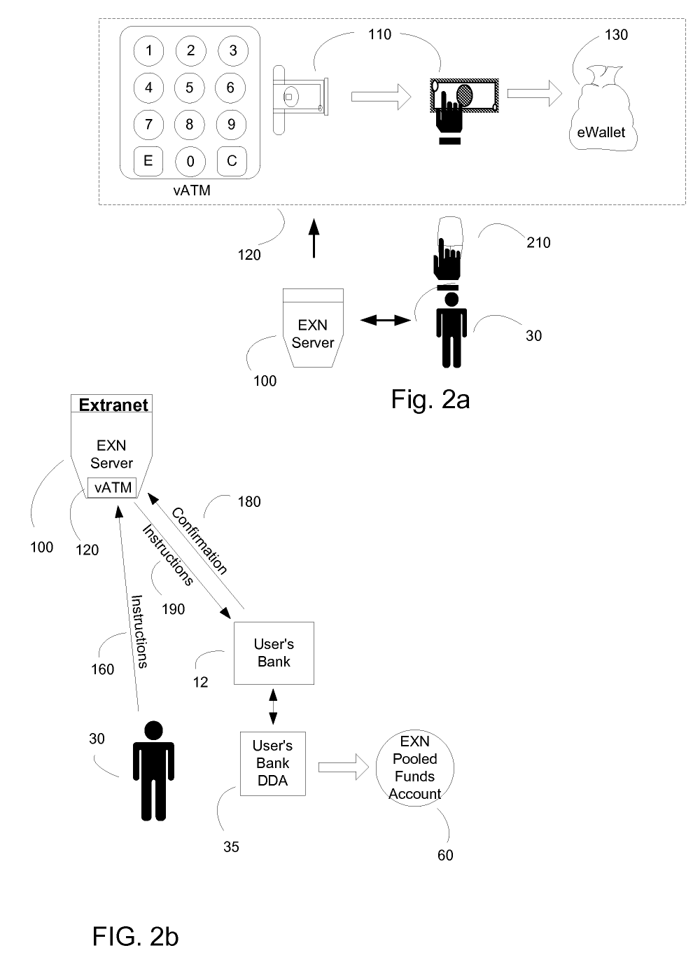

The process of obtaining e-cache requires a registered user to convert available funds in the user's DDA using a vATM under the control of the EXN Server. A typical vATM withdrawal transaction is shown in FIGS. 2a and 2b. FIG. 2a depicts a display that will be seen by a user making the transaction. Upon a user's indication that he or she wishes to convert available funds into e-cache, the display will show a vATM 120 into which an amount of e-cache to be converted may be entered. E-cache 110 will be dispensed and, using a computer mouse 210 or other pointing device, the user 30 can move the e-cache to the user's e-wallet 130. The physical act of moving the mouse 210 in a “drag and drop” operation constitutes the Purchaser's authorization to convert available funds from the user's bank account into e-cache.

This activity is mirrored in FIG. 2b, in which the user's movement of the mouse is translated into instructions 160 to the user's bank 12 to remove the designated funds from the user's demand deposit account (DDA) 35 and transfer them into the EXN Operator's pooled funds account 60. Upon receiving the user's instructions 160, the EXN Server 100 will instruct the user's bank 12 to make an intrabank transfer 190 whereby available funds are transferred from the user's bank account 35 into the EXN pooled account 60. Before executing instructions to convert funds, the EXN Server will query the user's DDA or eWallet to confirm 180 the existence of sufficient funds to complete the transaction.

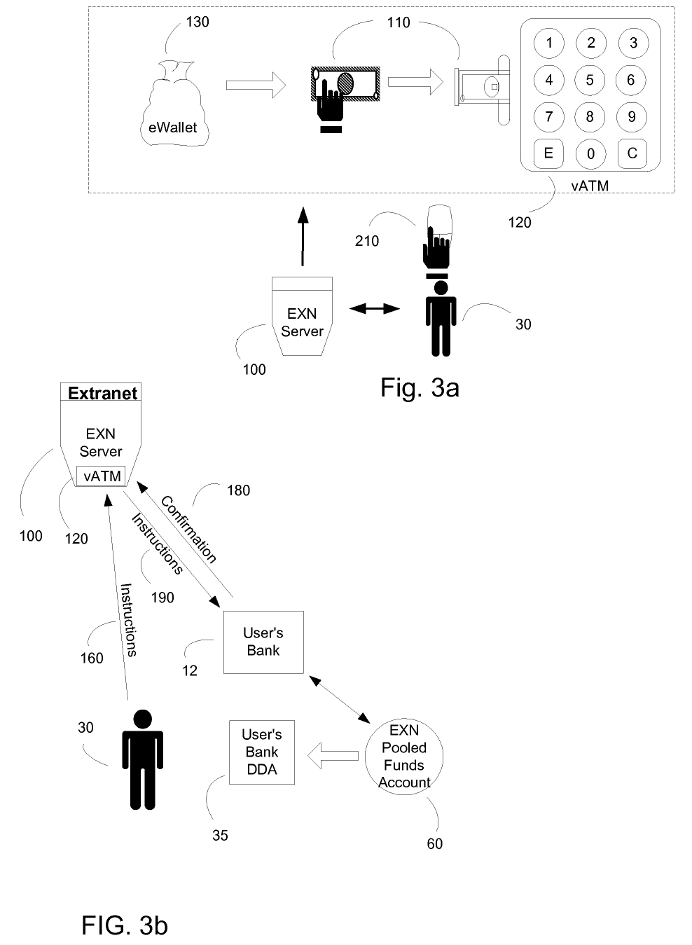

A transaction in which e-cache is reconverted into available funds is shown in FIGS. 3a and 3b. FIG. 3a depicts the user's experience in which e-cache 110 is moved from an eWallet 130 and is deposited into a vATM 120. The movement is again controlled using a computer mouse 210, and the user's action in “dragging” and “dropping” the e-cache upon the vATM icon constitutes legal authorization for the transfer. FIG. 3b shows the activities behind the e-cache reconversion. A user 30 opens a session with the EXN Server 100 and signifies that the vATM 120 will be used. Using the mouse, the user then “instructs” 160 the EXN Server 100 to withdraw a specified amount of funds from the EXN pooled account 60 and deposit them into the user's DDA 35. Before executing instructions to reconvert funds, the EXN Server will query its EXN pooled account to confirm 180 the existence of available funds to complete the transaction.

According to the invention, the EXN pooled accounts are in the nature of escrow accounts, and the total available funds held in all of the EXN pooled accounts will substantially equal the total amount of e-cache then existing in virtual space. However, as e-cache is reconverted to available funds, it may occur that there are insufficient funds in a particular EXN pooled account to fund an intrabank transfer of available funds into an account at that bank. This may occur, for example, in the case in which a merchant conducts numerous on-line transactions, accepting large amounts of e-cache in return for merchandise, and then wishes to reconvert the e-cache into available funds. In this case, the EXN Operator must initiate a transfer of available funds from one or more EXN pooled accounts in other banks into the EXN pooled account maintained in the merchant's bank. Such transfers will be formatted as ACH CCD (credit) transactions in which the EXN Operator will “push” funds from one EXN pooled account to another EXN pooled account. From there, available funds can be transferred into the merchant's DDA through an intrabank transfer.

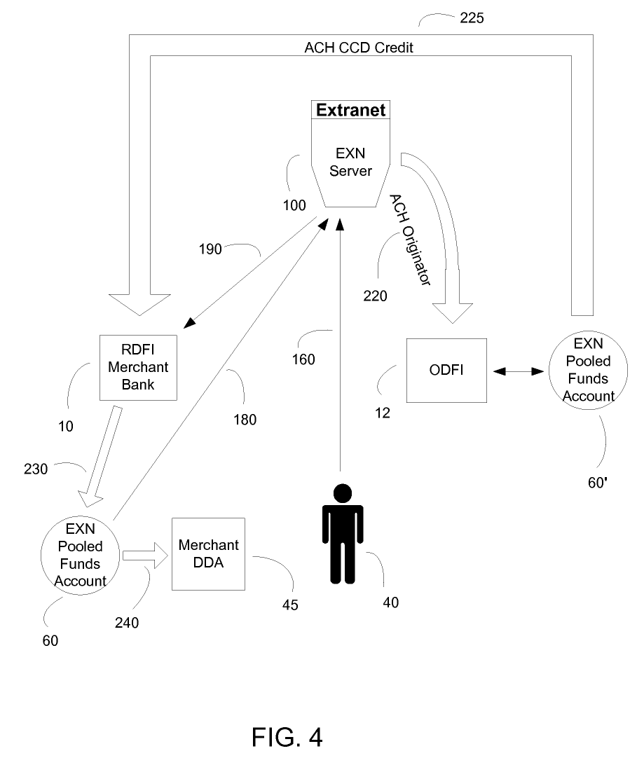

This condition is depicted in FIG. 4, in which a merchant 40 wishes to reconvert e-cache to available funds in its account 45. The merchant will provide instructions 160 to the EXN Server to reconvert e-cache into available funds. This is tantamount to a request that the EXN Operator “buy” e-cache from the merchant. Upon checking its available funds in the EXN pooled account 60 at the merchant's bank 10, the EXN Server determines that there are insufficient funds in that account to complete the requested transaction. The EXN Server will then format and present an ACH CCD (ACH commercial credit draft) 220 directing that an ACH transfer be made from one of the EXN Operator's other pooled accounts. The bank to whom the ACH CCD is presented will become an originating depository financial institution (ODFI) 12 in this transaction, and the bank that will receive the funds will be a receiving depository financial institution (RDFI) 10. Upon receiving the formatted ACH CCD 220, the ODFI will remove funds from the EXN pooled account 60′ at that institution and will “push” an ACH credit transfer 225 to the RDFI, which will deposit the funds into the EXN pooled account 60 at that bank. Upon receiving confirmation 180 that the transfer has been made, the EXN Server 100 will issue instructions 190 to the RDFI 10 to transfer available funds from the EXN pooled account 60 into the merchant's DDA 45. When this transfer 240 is carried out, the transaction is complete.

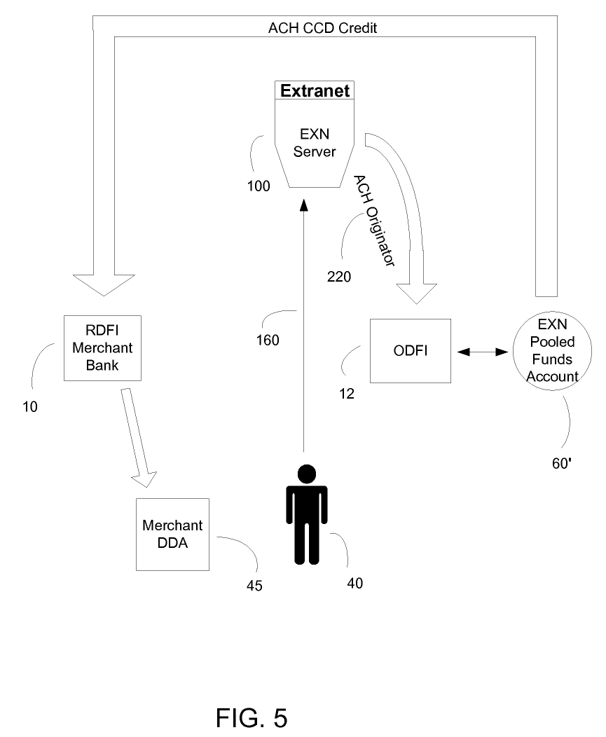

A similar situation may arise where a merchant who is registered to use the system keeps an account at a financial institution (such as a credit union) that does not maintain a pooled account for the EXN Operator. In FIG. 5, a merchant 40 has issued instructions 160 to the EXN Operator 100 to reconvert its e-cache into available funds. In this case, the EXN Server will format an ACH CCD 220 directing that available funds be transferred directly from a bank (ODFI) 12 that maintains an EXN pooled account 60′ into the merchant's account 45 at the merchant's bank (RDFI) 10.

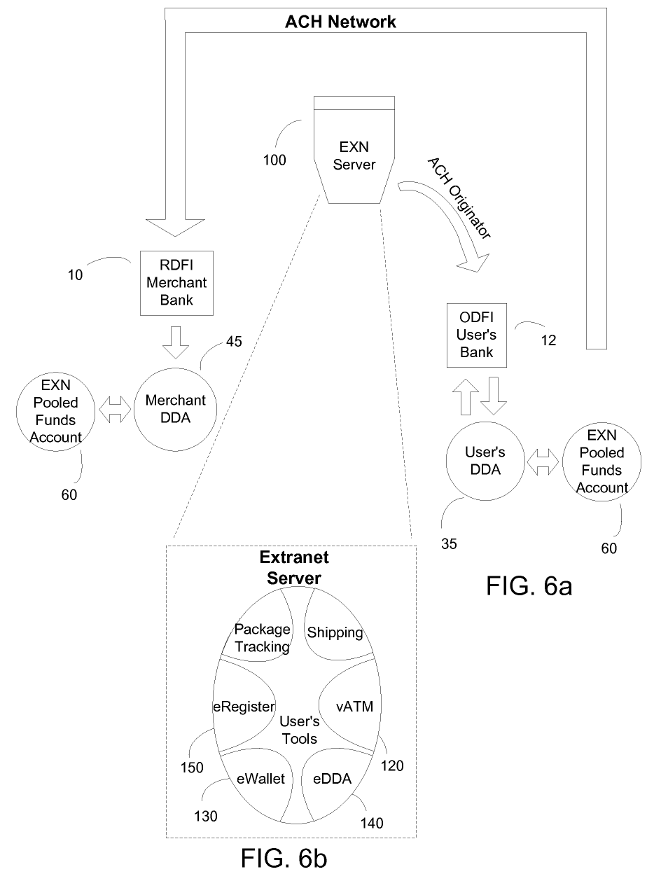

FIGS. 6a and 6b provide an overview of the primary functional features of the EXN Server 100. A user can use any of a number of available tools to control the making and settling of commercial remittance transactions over the internet or over a telephone network. Tools available to Extranet users include the vATM 120, an electronic Demand Deposit Account (e-Demand Deposit Account, or e-DDA) 140, an electronic Register (e-Register) 150, and an electronic Wallet (e-Wallet) 130. These tools are used to implement conveyance functions and transfer functions. Conveyance functions support customer-to-business transactions and peer-to-peer transactions, while transfer functions support electronic bill payment and presentation transactions and remote funds transfer transactions. Conveyance functions use e-cache, that is, animated tokens that appear in the form of a national currency, such as U.S. dollars and coins, that are stored in an eWallet, an eRegister, or an eDDA. Transfer functions use a virtual tender that appears in the form of a virtual wire stored in an eDDA.

The vATM 120, whose operation is depicted in FIGS. 2a and 3a, allows a user to withdraw e-cache from the user's bank account 35 and place the e-cache into the user's eWallet 130 for use in future transactions. The vATM tool facilitates the transposing of available funds in a user's account at his bank into e-cache, and facilitates the reverse transaction of decomposition of e-cache into available funds for withdrawal from the user's bank account. These tools are highly intuitive, acting through a series of commands that appear to mimic actual withdrawals and deposits at a bricks-and-mortar ATM.

The eWallet 130 is the on-line storage point for e-cache that the user intends to use for settlement of commercial remittance transactions for customer-to-business or peer-to-peer transactions. The eDDA 140 is an on-line storage point for virtual tender that the user intends to use for commercial remittance transactions involving electronic bill payment and presentation or for electronic funds (wire) transfer transactions.

In one embodiment, the eRegister 150 is a publicly disclosed universal repository that accepts e-cache from any source to settle commercial or private transactions on-line. Although anyone can deposit e-cache into an eRegister, only the merchant or other authorized owner of the account can withdraw available funds from an eRegister, or can remove e-cache from an eRegister for further use on the internet.

E-cache is not “timed out” nor destroyed after a certain period of time, but remains available to a user until it is transferred or reconverted into available funds and deposited into the user's account. E-cache can be conveyed or transferred by the user at any time the user wishes to make a commercial remittance transaction or wishes to transfer the e-cache to another Extranet user.

As shown in FIGS. 2a and 3a, e-cache tokens 110 are animated to allow the user to control the transaction by moving tokens on the computer's screen. Similarly, on a visual computer display, other icons are used to represent other entities or available functions. The selection of a particular icon to represent a given entity is a matter of personal choice, and it may be possible for users of the invention to select icons of their own choosing to represent entities and functions. Commercial remittance transactions are executed when a user “drags and drops” e-cache tokens upon an appropriate icon on the computer screen. As provided in operating agreements between the EXN Operator and registered users of the invention, this action constitutes legal authorization for the EXN Operator to perform the transaction indicated by the action.

In addition to converting available funds into e-cache for on-line purchases using an eWallet 130, e-cache can also be stored in an eDDA 140, and can thereafter be transferred to third party eBillers, or to another Extranet user. E-cache in the e-DDA 140 is also available for setting up and initiating bank-like wires transfers to other banks.

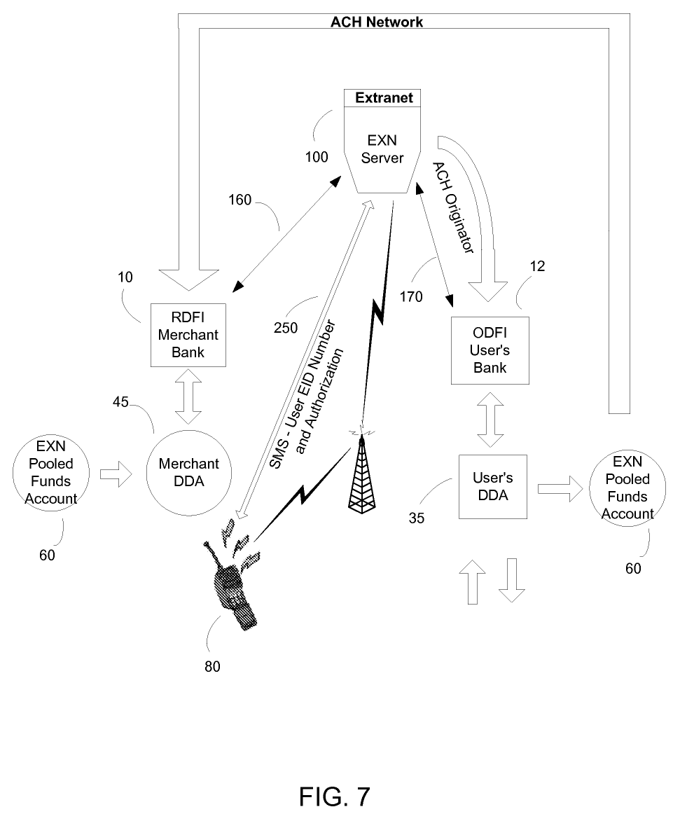

Another embodiment of this invention shown in FIG. 7 permits transactions to be authorized or confirmed through a mobile device at a time and place of the user's choosing. This embodiment adds an additional layer of security to the authentication and settlement of commercial remittance transactions over the internet As shown in FIG. 7, the Extranet user has the option of requiring that his or her mobile device 80 (cell phone, PDA, etc) be used as a personal real time authentication tool to authenticate commercial remittance transactions made over the internet or over a phone network. According to this embodiment, a short message service (SMS) text message 250 from the EXN Server 100 to the mobile device 80 will be used to confirm that the user is aware of and agrees to the commercial remittance transaction. This method also includes a requirement that the Extranet user must receive the SMS text message from the EXN Server 100, and then text message a response to the message that acts as a final release of the commercial remittance transaction. This method reduces the risk of fraud in transactions not initiated by the user or in transactions that the user may want to review before final acceptance.

Each member bank can make the EXN System available to its customers. Some embodiments of this invention can be made extraordinarily secure through the incorporation of a number of features. In one embodiment, using a confidential registration process between the bank and the bank's DDA customers (described below), the bank may issue a unique arbitrary number (having no similarities to the customer's personal account number at the bank) to identify a customer's account. All communications between the EXN Server and the bank related to the customer's account will use that number, which will otherwise be unknown to third parties, including the user.

The result is that actual bank routing numbers, personal bank account numbers, or other identifying information such as social security numbers, etc., need not be communicated to or from the EXN Server during financial transactions. A secure registration process, described below, ensures that arbitrary codes are generated and used to identify users and user's accounts involved in financial transactions. Because the user's personal alphanumeric code (“PAC”) is an arbitrary word used only in communications originating or terminating at the EXN Server, an eavesdropper or hacker learning it would not have sufficient information to identify a user or a user's bank account at the user's bank. The PAC is known to the EXN Server and, in some embodiments, may also be known to the bank hosting the user's account, and may be cross referenced to identify both the user and the user's bank account.

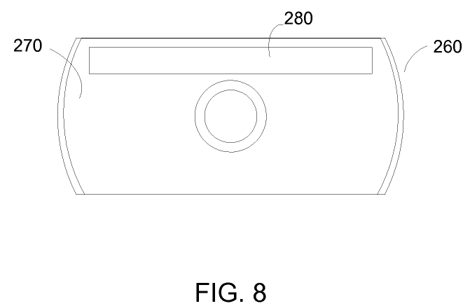

In addition, a further embodiment of this invention requires both the physical and the virtual credentials of the user to be present before secure transactions can be conducted using the Extranet. A physical device used in this embodiment is shown in FIG. 8, which depicts a credit card sized compact disc 260 that, when present in the user's CD or DVD disk drive, can be used to authenticate the user to the EXN Server. A user's PAC can be encrypted upon the recorded digital medium of the disk 270. If desired, further validation of the user's identity may be recorded on the disk in the form of a confidential question and response protocol. As a convenience to the user, a modified disk may be fabricated to the dimensions of a standard credit card and a magnetic strip (or an optical equivalent) 280 can be affixed to the disc, thereby enabling it to be read by standard card reading equipment. In this embodiment, a “card present” signal must be received by the EXN Server before any transactions will be permitted.

In practice, the question and response protocol can be maintained on the CD as an encrypted file to be accessed with a PIN or other key, or the challenge and response information may be maintained on the EXN Server. Information exchanged in the challenge and response protocol, such as, for example, the name of a favorite pet, or a mother's maiden name, which would not be known to a hacker, is normally sufficient to verify the user, and such information could therefore be maintained on the EXN Server without fear of revealing the identification of the user. In this case, when the CD is placed into a disc drive, the user would be required to enter a PIN in order to activate the CD. Upon activation, the CD would establish a connection with the Extranet and identify the user with the user's PAC. The EXN Server would then commence a series of questions and answers that would have to be successfully completed before transactions would be accepted by the EXN Server. As the physical disc (or other physical medium) and virtual credentials are available and known only to the user, the likelihood that a hacker or unauthorized third party could obtain the physical and virtual credentials necessary to commit a fraudulent transaction through the Extranet is substantially eliminated. For example, a fraudulent transaction could not be made where the unauthorized user knows only a user's PAC. The fraudulent user could not gain access to the Extranet unless the physical card, the personal identification number to unlock the CD (PIN), and the correct answers to the challenge and response questions are all present and are known to the fraudulent user.

A similar physical security regimen can be implemented for mobile phone users through a portable card reader that can be connected to a mobile phone. Once a connection to the EXN Server is established, the challenge and response procedure can be carried out over the telephone, and the user can be authenticated to the EXN Server for financial transactions.

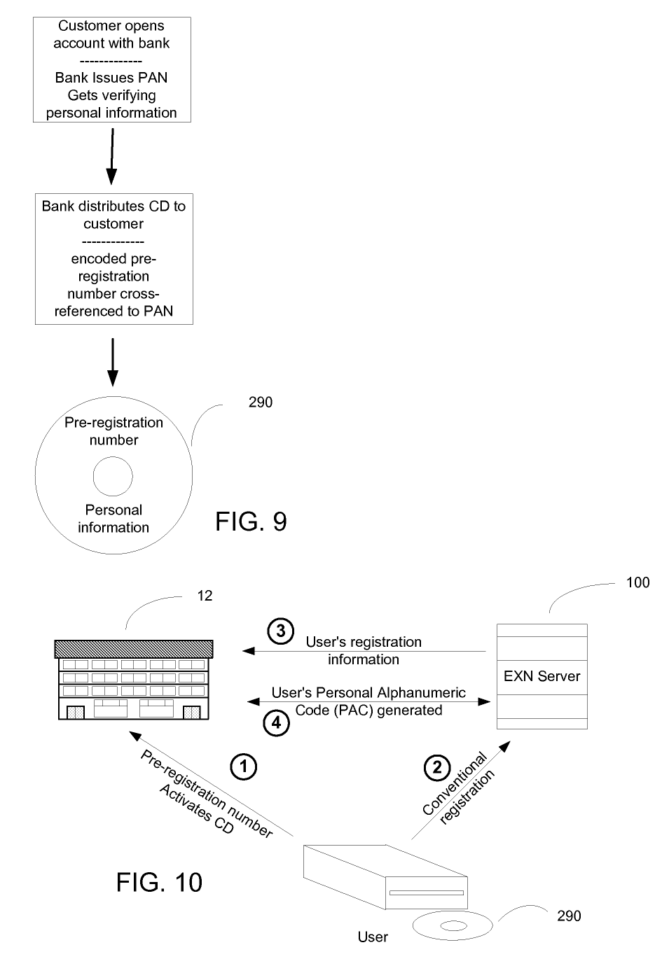

The registration of users of the Extranet is depicted in FIGS. 9 and 10. Registration is accomplished with the use of a temporary registration compact disc (CD) 290 that is distributed by the member bank 12 to the user. The method of registration takes place on two discrete levels: bank registration of the user with the user's bank, and Extranet registration of the user with the EXN Server.

In FIG. 9, the user must first open an account with a bank 12 having a contract with the EXN Operator 100. In one embodiment of this registration, the user provides the bank with personal information necessary to open the account and to subsequently identify the user as the owner of that account. The user is then given an pre-registration compact disc (CD) 290 that contains an encoded pre-registration number that will be used temporarily to identify the user to the bank. Although a CD is a preferred embodiment of the invention, it is possible that some other physical medium may be used, such as a magnetic encoded plastic card or a microchip suitable for use with a cellular phone, a hybrid personal data assistant (PDA), or some other suitable communications device.

At the bank, the user's pre-registration number is cross-referenced to the user's bank account number so that the user may be identified in subsequent electronic transmissions. The CD typically will also include the bank's routing number or IP address (to provide the EXN Server with sufficient information to connect to the bank when the user registers with the EXN Server) and the user's encoded pre-registration number, but will not include the user's bank account number. In one embodiment of the invention, shown in FIG. 10, the user will insert the CD into a computer that will establish an internet connection with the bank. If the user successfully answers a series of challenge and response questions based upon information the user gave to the bank when opening the account, the bank will activate the CD (or will give the user information to activate the CD). Once the registration CD has been activated, the user will be able to contact the EXN Server and register to use the Extranet.

After activating the CD, the user will register with the EXN Server. Upon accessing the EXN Server 100, the user will provide information for the EXN Server to register the user and to notify the bank 12 that the user has been registered. This step may be accomplished in any number of ways, including having the EXN Server communicate with the user's bank using the pre-registration number previously assigned to the user's CD; alternatively, the user may be identified to the bank with a bank-issued PAC or through personal information provided by the user. If it has not already occurred, during this phase of the registration, a PAC will be generated, and will thereafter permanently identify the user to the EXN Server and, in some embodiments, to the user's bank. If a single user has multiple accounts, a unique PAC may optionally be issued to identify each of the user's accounts.

The operation of the Extranet of this invention may be demonstrated in the following typical consumer purchase transaction that is conducted on-line across the internet. During the “boot up” process, the computer will automatically establish a connection with the EXN Server, notifying the server that the user's computer is on line. Alternatively, a user can manually establish a connection to the EXN Server, as when the user is using a guest computer. Once a connection with the EXN Server has been established, the user will be authenticated, and the EXN Server will be able to communicate with the user's computer during a shopping session.

The on-line transaction may commence with a Purchaser's conversion of available funds in the Purchaser's bank account into e-cache that can be used on-line in connection with the Extranet of this invention. The use of a vATM and its corresponding real world transaction are previously described in FIGS. 2a and 2b, and will result in a purchaser's having e-cache in an eWallet to make an on-line purchase.

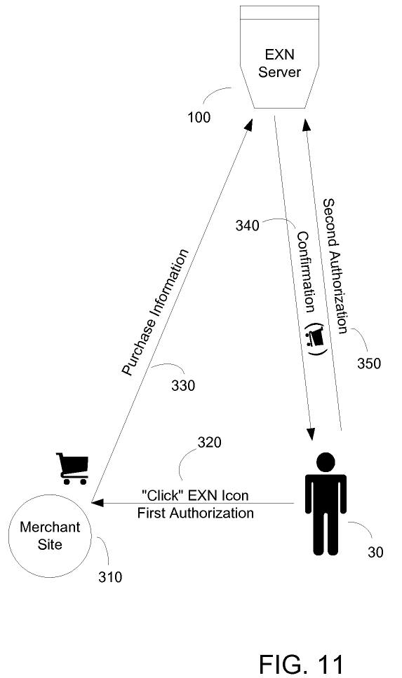

The transaction continues as shown in FIG. 11 in which the purchaser 30 is making an on-line purchase. The merchant's website 310 will display an Extranet icon to signify that buyers who are registered to use the Extranet can make secure purchases from that web site. This function will normally be activated after the purchaser has finished “shopping” and has placed items to be purchased into a virtual “shopping cart.” When the purchaser “clicks” the Extranet icon 320, the EXN Server 100 will be notified that a purchase is being made and the purchaser's selections will be provided to the server along with details of the purchase 330. This clicking action constitutes the purchaser's first authorization to make the purchase. The EXN Server will then activate separate sessions with the purchaser 30 and with the merchant's site 310, and will display the merchant's information to the purchaser to verify that the items the purchaser intends to purchase are the same as those that the merchant intends to sell. If the purchaser agrees, he or she will use the computer mouse to move e-cache from the purchaser's eWallet and place it on the eRegister icon representing the merchant, in a “drag and drop” motion 350. This action constitutes the purchaser's second authorization to make the purchase. Upon receiving the purchaser's second authorization, the EXN Server will move e-cache from the purchaser's account and record it to the merchant's account where it will thereafter be available to the merchant to fund purchases by the merchant, or to reconvert into available funds as previously described in FIGS. 3a and 3b. Also, upon a purchaser's making a purchase, the EXN Server will prepare and present a bill of sale to the purchaser and merchant upon which is recorded all relevant information generated in the transaction.

Other embodiments to this invention include the EXN Server's maintaining parcel shipping and tracking information, as are depicted in FIG. 6b. At the time a purchase is made, options for shipping the purchase can be provided and, if accepted, payment can be made to a shipper using e-cache. This transaction is identical to the described purchaser-merchant transaction. In addition, the EXN Server can maintain records of a user's purchases and shipments. Upon a purchaser's request, the EXN Server will provide a listing of purchases, and can also provide tracking information for specific purchases that have not yet been delivered.

Although a typical on-line consumer purchase transaction has been described in detail, the method of this invention is equally applicable to other on-line monetary transfers, such as those between merchants, or for on line bill paying, or for transactions between private persons.

The methods and processes described herein are illustrative of the processes of the invention, and the invention claimed herein is not limited by the processes disclosed, but only by the claims appended hereto.

I claim:

1. On a proprietary network accessible by a computer, said network being operated by a network operator and interconnecting at least one server and a plurality of terminals, said terminals being usable by members authorized to use said network, said members comprising at least one individual and one business entity, said network further being usable by one or more financial institutions that maintain demand deposit accounts for said members, a method for making secure electronic financial transactions comprising the steps of:
(a) maintaining a virtual monetary account for a member having a demand deposit account at one of said one or more financial institutions, said virtual monetary account being associated with said demand deposit account maintained by said member in said member's financial institution;
(b) maintaining a pooled funds account in at least one of said one or more financial institutions, said pooled funds account being controlled by said network operator;
(c) authenticating said member as being an authorized user of said network;
(d) providing an electronic visual interface at said terminals, said electronic visual interface being configurable to provide said member with information specific to said member's virtual monetary account and comprising a display of icons,
some of said icons representing available functions and other of said icons representing individuals or business entities, said icons including a movable virtual token icon representing money (e-cache),
said available functions comprising the conversion of available funds from said member's demand deposit account into e-cache, the conversion of e-cache into available funds in said member's demand deposit account, and the movement of e-cache to represent monetary transfers out of said member's virtual monetary account;
said electronic interface further providing said member with means to select and move one or more of said icons upon said electronic interface to execute one or more of said available functions,
(e) maintaining a database comprising records of transactions regarding said member's virtual monetary account;
(f) creating a record in said database comprising the function being selected and the movement of e-cache;
(g) and, if said selected function is a conversion of available funds in said member's demand deposit account into e-cache, instructing said member's financial institution to withdraw available funds from said member's demand deposit account and deposit said available funds into said pooled funds account, and updating said record to show said deposit of e-cache into said member's virtual account;
and, if said function is a conversion of e-cache into available funds, instructing said member's financial institution to withdraw available funds from said pooled account and deposit said available funds into said member's demand deposit account, and updating said record to showing said withdrawal of e-cache from said member's virtual account;
and if said function is a transfer of e-cache from said member's virtual account to another virtual account, updating said record to show said transfer of e-cache from said member's virtual account into said other virtual account.

2. A method of making electronic financial transactions as claimed in claim 1, further comprising the steps of:
registering a demand deposit account holder at said one or more financial institutions as a member authorized to provide instructions using said network;
providing said member with confidential information sufficient to identify and authenticate said member, and to authorize said member to issue instructions for managing said member's virtual account;
entering into an agreement with said member's financial institution whereby said financial institution authorizes said network operator to receive instructions from said member for managing said member's virtual account and to provide instructions to said member's financial institution for managing said member's demand deposit account.

3. A method of preventing fraud in electronic financial transactions as claimed in claim 2, in which the step of registering and authorizing a member to use said network further comprises:
said member's financial institution issuing an encoded pre-registration number to said member and maintaining information sufficient to electronically identify said member and said member's demand deposit account by reference to said encoded pre-registration number;
providing said member with a machine readable object containing said encoded pre-registration number;
said network operator registering said member with said network and receiving said member's encoded pre-registration number;
communicating said member's encoded pre-registration number to said member's financial institution,
said member's financial institution verifying said encoded pre-registration number and authorizing said member to use said network to provide instructions to said member's financial institution;
generating a unique alphanumeric code cross referenced to said member's demand deposit account and using said unique alphanumeric code on said network to identify said member to said member's financial institution.

4. A method of preventing fraud in electronic financial transactions as claimed in claim 1, wherein the step of member authentication further comprises recording said member's personal alphanumeric code and a personal identification number (PIN) onto a machine-readable object; inserting said machine-readable object into a reader connected to said member's network terminal; entering said PIN into said network terminal to verify said member's authorization to use said machine-readable object;
presenting said member with one or more questions having predetermined answers previously provided by said member;
said member entering answering information into said network terminal comprising answers corresponding to said predetermined answers;
communicating said unique alphanumeric code to said network;
granting said member access to conduct transactions using said network.

5. A method of preventing fraud in electronic financial transactions as claimed in claim 4 wherein said network terminal comprises a computer.

6. A method of preventing fraud in electronic financial transactions as claimed in claim 4 wherein said network terminal comprises a wireless device using a cellular telephone network.

7. A method of preventing fraud in electronic financial transactions as claimed in claim 4 wherein said network terminal comprises an automated teller machine.

8. A method of preventing fraud in electronic financial transactions as claimed in claim 4 wherein said one or more questions having predetermined answers are communicated to said member from said network operator, and said answering information is communicated from said network terminal to said network operator.

9. A method of preventing fraud in electronic financial transactions as claimed in claim 4 wherein said one or more questions having predetermined answers are included in said one or more encoded information files included on said machine-readable object, and said predetermined answers are included in said one or more encoded information files included on said machine-readable object.

10. A method of preventing fraud in electronic financial transactions as claimed in claim 1 wherein said pooled accounts fund comprises a plurality of pooled accounts funds owned by said network operator and maintained in a plurality of financial institutions.

11. A method of preventing fraud in an electronic financial transaction comprising the steps of:
establishing a virtual private network (VPN), said VPN further comprising a VPN server, a VPN operator, a plurality of financial institutions, one or more pooled funds accounts owned by said VPN operator and maintained at one or more of said plurality of financial institutions, and a plurality of users authorized to use said VPN, said plurality of users comprising at least some individuals and at least some commercial entities;
each financial institution in said plurality of financial institutions being connected to said VPN and being in communication with said VPN server, each commercial entity in said plurality of commercial entities being connected to said VPN and being in communication with said VPN server, each user in said plurality of users having at least one direct deposit account (DDA) in at least one of said member financial institutions and a corresponding virtual account maintained by said VPN server, each said user being authorized to connect to said VPN and communicate with said VPN server;
said VPN server receiving instructions from a first user to withdraw available funds from said first user's DDA account in said first user's financial institution as e-cache to be placed in said first user's virtual account;
said VPN server instructing said first user's financial institution to transfer said available funds from said first user's DDA into a first pooled funds account;
said VPN server making a record of a deposit of e-cache into said first user's virtual account and notifying said first user that said e-cache is available to said first user;
said VPN server receiving instructions from said first user to transfer at least a portion of said e-cache to a second user;
said VPN server creating a record of a transfer of e-cache from said first user's virtual account to a virtual account owned by said second user;
said VPN server receiving instructions from said second user to convert e-cache in second user's virtual account into available funds in said second user's DDA maintained at said second user's financial institution;
said VPN server instructing said second user's financial institution to transfer available funds from a second pooled funds account into said second user's DDA;
said VPN server notifying said second user that available funds have been deposited into said second user's DDA at said second user's financial institution.

12. A method of preventing fraud in an electronic financial transaction as claimed in claim 11 further comprising the step of said VPN server instructing said first user's financial institution to initiate a transfer of available funds from said first pooled funds account to said second pooled funds account using an automated clearing house (ACH) commercial credit draft.

13. A method of preventing fraud in an electronic financial transaction as claimed in claim 11, further comprising the step of presenting to said first user a visual animated display representing said withdrawal of available funds from said first user's DDA account in said first user's financial institution as e-cache, said first user's placing said e-cache in said first user's virtual account, and said first user transferring said e-cache to said second user;
said animated display comprising an icon representing an electronic automated teller machine (eATM), cash-like authentication tokens representing said e-cache, an icon representing a repository for holding said first user's e-cache, one or more icons representing potential recipients of said e-cache including an icon representing said second user, and at least one icon representing a pointer by which said first user can select and move said e-cache;
said animated display visually depicting said user's moving said pointer to withdraw e-cache from said eATM, moving said pointer to place e-cache from said eATM into said repository for holding said first user's e-cache, and moving said pointer to transfer e-cache out of said first user's repository and to said icon representing said second user.

14. A method of preventing fraud in a financial transaction as claimed in claim 13, in which said first pooled funds account and said second pooled funds account are the same pooled funds account.

15. A method of preventing fraud in a financial transaction as claimed in claim 13 in which said first user's financial institution and said second user's financial institution are the same financial institution.

16. A method of preventing fraud in electronic financial transactions comprising the steps of:
establishing a proprietary network including at least the internet and one or more cellular wireless networks interconnecting a proprietary network server, one or more financial institutions, and at least one user, said user having a demand deposit account (DDA) in one of said financial institutions and having a virtual monetary account maintained by said proprietary network server and associated with said DDA, said user being authorized to use said proprietary network and having a cellular telephone that is connected to said one or more cellular wireless networks such that said cellular telephone can communicate with said proprietary network server,
said user being identified and authenticated to said proprietary network server through said cellular telephone;
said user providing instructions to said proprietary network server to prepare a transfer of funds from said user's virtual monetary account to an identified entity;
said proprietary network server notifying said user that all conditions necessary to initiate said transfer of funds have been satisfied;
said user providing instructions via said cellular telephone and said one or more cellular wireless network to said proprietary network server to transfer said funds to said identified entity.

17. A method of preventing fraud in electronic financial transactions as claimed in claim 16, said step of said user being identified and authenticated to said proprietary network server through said cellular telephone further comprising the steps of:
said proprietary network server sending information to said user through a short message service (SMS) message sent to said user's cellular telephone;
said user sending an SMS message to said proprietary network server, said user's SMS message including identifying information authenticating said user's identity and authorization to access said proprietary network server;
said proprietary network server receiving said user's SMS message and comparing said identifying information with corresponding identifying information previously provided by said user;
and if said comparison of identifying information authenticates said user's identity and authorization to conduct transactions using said proprietary network server, accepting instructions from said user.

18. A method of preventing fraud in electronic financial transactions as claimed in claim 17 further comprising said cellular telephone having means for reading encoded identifying information stored on a machine-readable object, and said user providing a machine-readable object to said cellular telephone whereby said user's SMS message to said proprietary network server includes said encoded identifying information.

19. A method of preventing fraud in electronic financial transactions as claimed in claim 17 further comprising said cellular telephone communicating to said proprietary network server that a physical authenticating object is present.

20. A method of preventing fraud in electronic financial transactions comprising the steps of:
establishing a proprietary network using the internet;
connecting to said proprietary network a proprietary network server, one or more financial institutions, one or more commercial merchants, at least one purchaser having at least one demand deposit account in one of said one or more financial institutions, and a plurality of terminals whereby each user of said proprietary network can communicate with said proprietary network server;
authorizing said purchaser to conduct financial transactions using said proprietary network;
said one or more commercial merchants and said at least one purchaser having virtual monetary accounts maintained by said proprietary network server;
one of said one or more commercial merchants establishing an internet site through which said commercial merchant offers products or services for purchase over the internet;
said commercial merchant displaying information on said internet site notifying prospective purchasers that financial transactions may be conducted with said commercial merchant using said proprietary network and including a proprietary network icon to be selected when a purchase is to be made using said proprietary network;
said purchaser selecting products or services to be purchased from said commercial merchant;
said purchaser notifying said proprietary server that a purchase is being made using said proprietary network by selecting said proprietary network icon;
said proprietary network presenting said purchaser with a visual display containing movable icons representing e-cache in said purchaser's virtual monetary account and providing said purchaser with means for moving said e-cache icons from said purchaser's virtual monetary account to an icon representing said commercial merchant's virtual account;
said purchaser authorizing said purchase by moving said e-cache icons to said icon representing said commercial merchant's virtual account;
said proprietary network server creating a record indicating the transfer of e-cache from said purchaser's virtual monetary account to said commercial merchant's virtual monetary account.

21. A method of preventing fraud in electronic financial transactions as claimed in claim 20, said step of authorizing said purchaser to conduct transactions using said proprietary network further comprising the steps of placing encoded identification and authentication information upon a machine-readable physical object; placing said machine-readable physical object into a reader attached to said terminal; entering information on said terminal; comparing said entered information to said encoded information; and if said entered information corresponds to said encoded information, authorizing said purchaser to conduct transactions using said proprietary network.

22. A method of preventing fraud in electronic financial transactions as claimed in claim 20 wherein said e-cache icons can be represented in any one of a plurality of international currencies.
